(19) United States
(12) Patent Application Publication
(10) Pub. No.: US 2022/0308793 A1
(43) Pub. Date: Sep. 29, 2022

(54) METHOD FOR WRITING DATA IN PARALLEL AND DATA STORAGE SYSTEM

(71) Applicant: Acer Incorporated, New Taipei City (TW)

(72) Inventors: Guan-Yu Hou, New Taipei City (TW); Tz-Yu Fu, New Taipei City (TW)

(73) Assignee: Acer Incorporated, New Taipei City (TW)

(21) Appl. No.: 17/317,907

(22) Filed: May 12, 2021

(30) Foreign Application Priority Data
Mar. 25, 2021 (TW) 110110890

(51) Int. Cl. G06F 3/06; G06F 13/16; G06F 13/42

(52) U.S. Cl. CPC G06F 3/0659; G06F 3/0604; G06F 3/0653; G06F 3/0683; G06F 13/1668; G06F 13/4282; G06F 2213/0026

(57) ABSTRACT

A method for writing data in parallel and a data storage system are provided. The method includes the following. A data writing performance of a first memory device and a second memory device is evaluated. A first data volume per write unit of the first memory device and a second data volume per write unit of the second memory device are determined, and the first data volume per write unit is different from the second data volume per write unit. The first memory device and the second memory device are instructed to perform a parallel data write according to the first data volume per write unit and the second data volume per write unit.

### CROSS-REFERENCE TO RELATED APPLICATION

This application claims the priority benefit of Taiwan application serial no. 110110890, filed on Mar. 25, 2021. The entirety of the above-mentioned patent application is hereby incorporated by reference herein and made a part of this specification.

### BACKGROUND

### Technical Field

The disclosure relates to a technology of writing data in parallel for a memory device, and in particular to a method for writing data in parallel and a data storage system.

### Description of Related Art

With the advancement of technology, new types and versions of memory devices are constantly being introduced. When users install different models or versions of memory device on a same motherboard and use the memory devices at the same time, even if an individual data writing performance of each memory device is good, a parallel data writing performance of these memory devices still might not be improved and might even slightly decrease due to uncoordinated operation between the memory devices.

### SUMMARY

The disclosure provides a method for writing data in parallel and a data storage system. The disclosure improves a parallel data writing performance of a data storage system including a plurality of memory devices.

An embodiment of the disclosure provides a method for writing data in parallel adapted for a data storage system. The data storage system includes a first memory device and a second memory device. The method for writing data in parallel includes the following. A data writing performance of the first memory device and the second memory device is evaluated. A first data volume per write unit of the first memory device and a second data volume per write unit of the second memory device are determined according to the data writing performance, and the first data volume per write unit is different from the second data volume per write unit. The first memory device and the second memory device are instructed to perform a parallel data write according to the first data volume per write unit and the second data volume per write unit.

Another embodiment of the disclosure provides a data storage system including a host system, a first memory device, and a second memory device. The first memory device is connected to the host system via a first connection interface. The second memory device is connected to the host system via a second connection interface. The host system is configured to evaluate a data writing performance of the first memory device and the second memory device. The host system is further configured to determine a first data volume per write unit of the first memory device and a second data volume per write unit of the second memory device according to the data writing performance. The first data volume per write unit is different from the second data volume per write unit. The host system is further configured to instruct the first memory device and the second memory device to perform a parallel data write according to the first data volume per write unit and the second data volume per write unit.

Based on the above, after the individual data writing performance of the first memory device and the second memory device in the data storage system is evaluated in real time, the first data volume per write unit of the first memory device and the second data volume per write unit of the second memory device may be determined, and the first data volume per write unit is different from the second data volume per write unit. Thereafter, the first memory device and the second memory device are instructed to perform the parallel data write according to the first data volume per write unit and the second data volume per write unit, so as to improve the parallel data writing performance of the data storage system including the plurality of memory devices.

### BRIEF DESCRIPTION OF THE DRAWINGS

FIG. 1 is a schematic diagram of a data storage system according to an embodiment of the disclosure.

FIGS. 2A and 2B are schematic diagrams of evaluating a data writing performance of a first memory device according to an embodiment of the disclosure.

FIGS. 3A and 3B are schematic diagrams of evaluating a data writing performance of a second memory device according to an embodiment of the disclosure.

FIG. 4 is a schematic diagram of the first memory device and the second memory device performing a parallel data write based on a default data volume per write unit according to an embodiment of the disclosure.

FIG. 5 is a schematic diagram of the first memory device and the second memory device performing a parallel data write according to a dynamically determined data volume per write unit according to an embodiment of the disclosure.

FIG. 6 is a flow chart of a method for writing data in parallel according to an embodiment of the disclosure.

### DESCRIPTION OF THE EMBODIMENTS

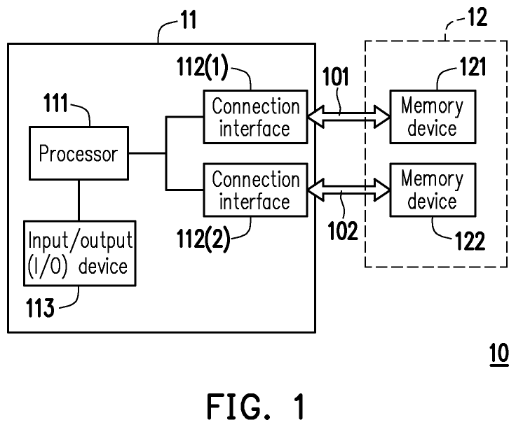

FIG. 1 is a schematic diagram of a data storage system according to an embodiment of the disclosure. Referring to FIG. 1, a data storage system 10 includes a host system 11 and a memory storage system 12. The host system 11 may store data in the memory storage system 12, or read data from the memory storage system 12. For example, the host system 11 is any system that may substantially cooperate with the memory storage system 12 to store data, for example, a computer system, a digital camera, a camera, a communication device, an audio player, a video player or a tablet computer, and the memory storage system 12 may be various types of nonvolatile memory devices, for example, a flash drive, a memory card, a solid state drive (SSD), a secure digital (SD) card, a compact flash (CF) card, or an embedded storage device.

In an embodiment, the host system 11 may include a processor 111, a connection interface 112(1), a connection interface 112(2), and an input/output (I/O) device 113. The processor 111 is electrically connected to the connection interface 112(1), the connection interface 112(2), and the input/output (I/O) device 113. The processor 111 may be responsible for the operation of the entirety or a part of the host system 11. For example, the processor 111 may include a central processing unit (CPU) or other programmable general-purpose or special-purpose devices, for example, a micro-processor, a digital signal processor (DSP), a programmable controller, application specific integrated circuits (ASIC), a programmable logic device (PLD), or a similar device or a combination thereof.

The connection interfaces 112(1) and 112(2) are configured to connect the host system 11 to the memory storage system 12. For example, the connection interfaces 112(1) and 112(2) may be respectively electrically connected to the memory storage system 12 via channels 101 and 102. The processor 111 may access the memory storage system 12 via the connection interfaces 112(1) and 112(2) (or the channels 101 and 102). The input/output (I/O) device 113 may include any input/output interface required in practice, for example, a network interface card, a keyboard (or a touchpad), a screen and/or a speaker, etc.

In an embodiment, the connection interfaces 112(1) and 112(2) conform to connection interface standards such as Peripheral Component Interconnect Express (PCI Express). In addition, the connection interfaces 112(1) and 112(2) conform to the NVM Express (NVMe) specification.

In an embodiment, the memory storage system 12 includes memory devices 121 and 122. The memory device 121 is also referred to as a first memory device. The memory device 122 is also referred to as a second memory device. The memory device 121 is electrically connected to the connection interface 112(1) via the channel 101. The memory device 122 is electrically connected to the connection interface 112(2) via the channel 102. It is to be noted that in an embodiment, the memory storage system 12 may further include other memory devices. In addition, in an embodiment, the memory storage system 12 is also referred to as a redundant array of independent disks (RAID) storage system.

In an embodiment, the memory device 121 includes a memory module (not shown) and a memory controller (not shown). The memory module is configured to store data written by the host system 11. The memory controller is electrically connected to the memory module and is configured to access the memory module according to an instruction from the host system 11, for example, to perform a data read, write, or erase operation on the memory module.

In an embodiment, the memory module in the memory device 121 may include a single level cell (SLC) NAND flash memory module (that is, a flash memory module in which one memory cell may store 1-bit data), a multi level cell (MLC) NAND flash memory module (that is, a flash memory module in which one memory cell may store 2-bit data), a triple level cell (TLC) NAND flash memory module (that is, a flash memory module in which one memory cell may store 3-bit data) and/or a quad level cell (QLC) NAND flash memory module (that is, a flash memory module in which one memory cell may store 4-bit data).

In an embodiment, the memory cell in the memory module stores data by changing the critical voltage. For example, the memory module may include a plurality of physical units. Each physical unit may include a plurality of memory cells. For example, one physical unit may include one or more physical pages, one or more physical blocks, or one or more other memory cell management units. Memory cells belonging to the same physical page may be programmed at the same time to store data. Memory cells belonging to the same physical block may be erased at the same time to clear data. In an embodiment, the memory module is also referred to as a flash memory module, and/or the memory controller is also referred to as a flash memory controller. In addition, the memory device 122 may be the same as or similar to the memory device 121, and will not be repeated herein.

In an embodiment, the memory devices 121 and 122 both support NVMe access operation. The processor 111 may issue a control instruction via the channels 101 and 102 to access the memory devices 121 and 122 in parallel. For example, when data is to be stored, the processor 111 may issue a write instruction to the memory devices 121 and 122 respectively via the channels 101 and 102, so as to instruct the memory devices 121 and 122 to perform a parallel data write. During parallel data write, the memory devices 121 and 122 may store data from the host system 11 to respective memory modules of the memory devices 121 and 122 in parallel. Alternatively, when data is to be read, the processor 111 may issue a read instruction to the memory devices 121 and 122 respectively via the channels 101 and 102, so as to instruct the memory devices 121 and 122 to perform a parallel data read. During parallel data read, the memory devices 121 and 122 may read data from respective memory modules of the memory devices 121 and 122 in parallel and transmit the data to the host system 11. In an embodiment, the processor 111 may access the memory devices 121 and 122 via a control interface or a driver interface.

In an embodiment, the processor 111 may evaluate the respective data writing performance of the memory devices 121 and 122. This data writing performance may reflect the data writing speed of the memory devices 121 and 122 when the memory devices 121 and 122 respectively store data from the host system 11. The processor 111 may determine the data volume per write unit of the memory device 121 (also referred to as a first data volume per write unit) and the data volume per write unit of the memory device 122 (also referred to as a second data volume per write unit) according to the evaluated data writing performance). It is to be noted that the first data volume per write unit may be different from the second data volume per write unit. Thereafter, the processor 111 may instruct the memory devices 121 and 122 to perform a parallel data write according to the first data volume per write unit and the second data volume per write unit.

In an embodiment, the processor 111 may measure the data write bandwidth of the memory device 121 (also referred to as a first data write bandwidth) and the data write bandwidth of the memory device 122 (also referred to as a second data write bandwidth) in real time. Next, the processor 111 may evaluate the respective data writing performance of the memory devices 121 and 122 according to the first data write bandwidth and the second data write bandwidth. For example, the first data write bandwidth and the second data write bandwidth may respectively reflect and are positively correlated with the respective data writing speed of the memory devices 121 and 122.

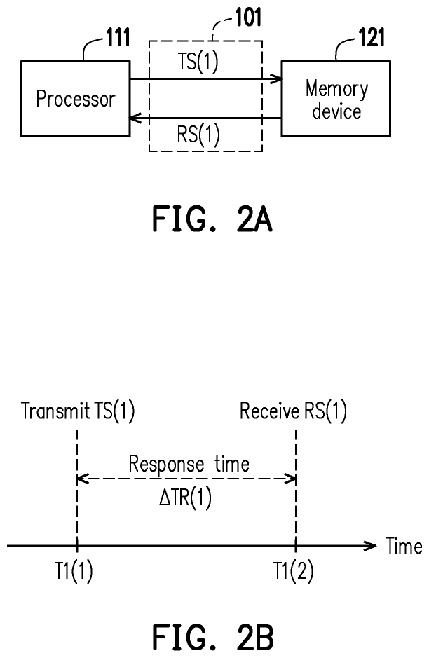

FIGS. 2A and 2B are schematic diagrams of evaluating a data writing performance of the first memory device according to an embodiment of the disclosure. Referring to FIG. 2A, in an embodiment, the processor 111 may transmit a test signal TS(1) to the memory device 121 via the channel 101. The test signal TS(1) contains a test write instruction (also referred to as a first test write instruction). The memory device 121 may receive the test signal TS(1) and perform a data write operation according to the test signal TS(1) to store the data instructed to be stored by the first test write instruction. After finishing the data write operation, the memory device 121 may reply a response signal RS(1) via the channel 101. The response signal RS(1) may be configured to notify the processor 111 that the write operation corresponding to the test signal TS(1) (or the first test write instruction) is completed.

Referring to FIG. 2B, assume that the processor 111 transmits the test signal TS(1) at a time point T1(1) and receives the response signal RS(1) at a time point T1(2) later. The processor 111 may derive the response time (also referred to as a first response time) of the memory device 121 with regard to the test signal TS(1) (or the first test write instruction) according to a time difference ΔTR(1) between the time points T1(1) and T1(2). The processor 111 may measure the data write bandwidth of the memory device 121 and/or the data writing performance of the memory device 121 according to the first response time (or ΔTR(1)). For example, if the first response time (or ΔTR(1)) is shorter, the processor 111 may determine that the data write bandwidth of the memory device 121 is larger and/or the data writing performance of the memory device 121 is better. In an embodiment, the processor 111 may actually calculate the data write bandwidth of the memory device 121 according to the first response time (or ΔTR(1)).

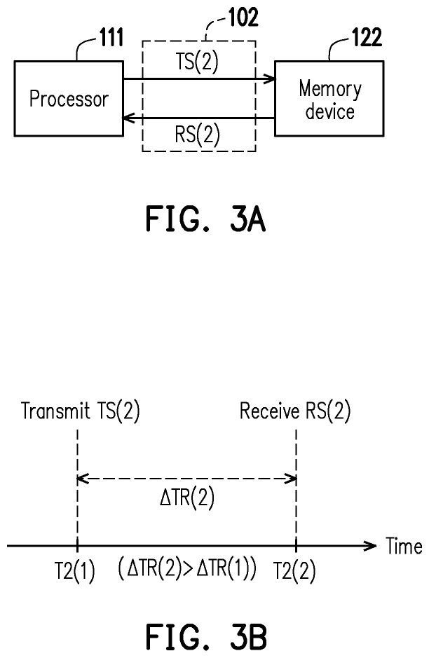

FIGS. 3A and 3B are schematic diagrams of evaluating a data writing performance of the second memory device according to an embodiment of the disclosure. Referring to FIG. 3A, in an embodiment, the processor 111 may transmit a test signal TS(2) to the memory device 122 via the channel 102. The test signal TS(2) contains a test write instruction (also referred to as a second test write instruction). The memory device 122 may receive the test signal TS(2) and perform a data write operation according to the test signal TS(2) to store the data instructed to be stored by the second test write instruction. After finishing the data write operation, the memory device 122 may reply a response signal RS(2) via the channel 102. The response signal RS(2) may be configured to notify the processor 111 that the write operation corresponding to the test signal TS(2) (or the second test write instruction) is completed.

Referring to FIG. 3B, assume that the processor 111 transmits the test signal TS(2) at a time point T2(1) and receives the response signal RS(2) at a time point T2(2) later. The processor 111 may derive the response time (also referred to as a second response time) of the memory device 122 with regard to the test signal TS(2) (or the second test write instruction) according to a time difference ΔTR(2) between the time points T2(1) and T2(2). The processor 111 may measure the data write bandwidth of the memory device 122 and/or the data writing performance of the memory device 122 according to the second response time (or ΔTR(2)). For example, if the second response time (or ΔTR(2)) is shorter, the processor 111 may determine that the data write bandwidth of the memory device 122 is larger and/or the data writing performance of the memory device 122 is better. In an embodiment, the processor 111 may actually calculate the data write bandwidth of the memory device 122 according to the second response time (or ΔTR(2)).

In an embodiment, it is assumed that the connection interface 112(1) (or the memory device 121) conforms to the PCIe Gen 4 specification, and the connection interface 112(2) (or the memory device 122) conforms to the PCIe Gen 3 specification. Therefore, in an embodiment, the first response time (or ΔTR(1)) is shorter than the second response time (or ΔTR(2)), and the data write bandwidth of the memory device 121 is greater than the data write bandwidth of the memory device 122, and/or the data writing performance of the memory device 121 is higher than the data writing performance of the memory device 122. However, in another embodiment, the connection interfaces 112(1) and 112(2) may conform to other connection interface standards, and the disclosure is not limited thereto.

In an embodiment, the processor 111 may determine the first data volume per write unit and the second data volume per write unit according to the ratio of the first data write bandwidth to the second data write bandwidth. For example, assume that the measured first data write bandwidth and second data write bandwidth are respectively 5000 MB/s and 3000 MB/s. The processor 111 may derive the ratio of the first data write bandwidth to the second data write bandwidth to be about 1.67. In an embodiment, the ratio of the first data write bandwidth to the second data write bandwidth may be replaced by the ratio of the first response time (or ΔTR(1)) to the second response time (or ΔTR(2)). The processor 111 may determine the first data volume per write unit and the second data volume per write unit according to the above ratio. For example, after the ratio of the first data write bandwidth to the second data write bandwidth (for example, 1.67) is input to an equation or a lookup table, the processor 111 may determine the first data volume per write unit to be 128K and the second data volume per write unit to be 64K according to the output of the equation or the lookup table. Thereafter, the processor 111 may instruct the memory devices 121 and 122 to perform a parallel data write according to the first data volume per write unit (for example, 128K) and the second data volume per write unit (for example, 6K).

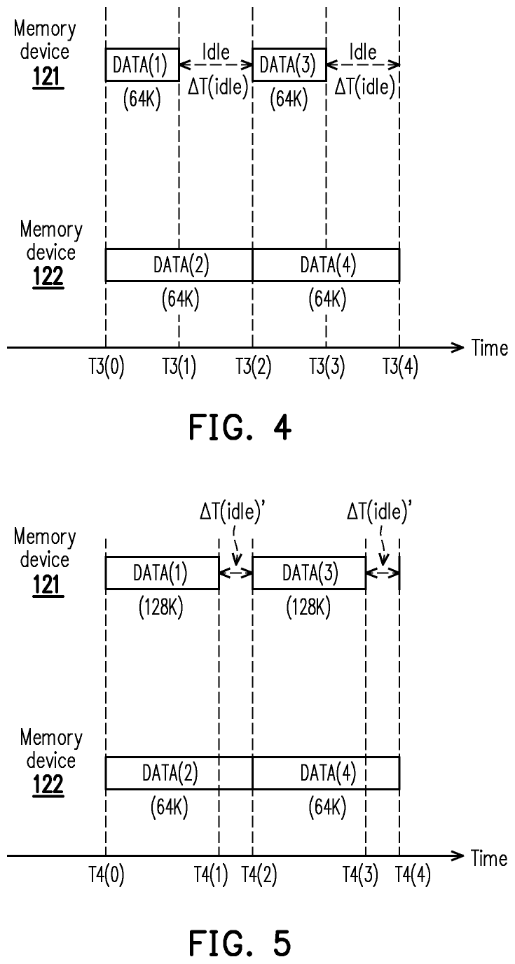

FIG. 4 is a schematic diagram of the first memory device and the second memory device performing a parallel data write based on a default data volume per write unit according to an embodiment of the disclosure. Referring to FIG. 4, in an embodiment, in a state where the first data volume per write unit and the second data volume per write unit are not dynamically adjusted, the first data volume per write unit and the second data volume per write unit are both a default value. For example, the default value may be 64K. When the memory devices 121 and 122 perform a parallel data write, data DATA(1) and DATA(2) may be written to the memory devices 121 and 122 in parallel between time points T3(0) and T3(2). The data volume of data DATA(1) conforms to the first data volume per write unit, and the data volume of DATA(2) conforms to the second data volume per write unit, and the first data volume per write unit and second data volume per write unit are both 64K.

It is to be noted that assume that the data writing performance of the memory device 121 is higher than the data writing performance of the memory device 122 (for example, the data write bandwidth of the memory device 121 is about 1.67 times the data write bandwidth of the memory device 122). Therefore, in the embodiment of FIG. 4, based on the default data volume per write unit, the writing of 64K data DATA(2) by the memory device 122 is finished at about the time point T3(2), and the writing of data DATA(1) by the memory device 121 may be finished at a time point T3(1), which is earlier than T3(2). In a time range ΔT(idle) between the time points T3(1) and T3(2), the memory device 121 with a higher data writing performance is in an idle state. In other words, in the time range ΔT (idle), the bandwidth resource of the memory device 121 with a higher data writing performance is wasted.

After the time point T3(2), the memory devices 121 and 122 may continue to perform a next parallel data write. For example, between the time point T3(2) and a time point T3(4), data DATA(3) and DATA(4) conforming to the default data volume per write unit (for example, 64K) may be written to the memory devices 121 and 122 in parallel, and so on. It is to be noted that in some cases, if the parallel data write as shown in FIG. 4 is performed based on the default data volume per write unit for a long time, an ideal parallel data writing performance of a plurality of memory devices may not be achieved, and individual data writing performances of some of the memory devices may even be slowed down.

FIG. 5 is a schematic diagram of the first memory device and the second memory device performing a parallel data write according to a dynamically determined data volume per write unit according to an embodiment of the disclosure. Referring to FIG. 5, in an embodiment, the first data volume per write unit and the second data volume per write unit may be dynamically determined according to the first data write bandwidth and the second data write bandwidth. For example, assuming that the ratio of the first data write bandwidth to the second data write bandwidth is about 1.67, the first data volume per write unit and the second data volume per write unit may respectively be configured to be 128K and 64K. It is to be noted that the first data volume per write unit and second data volume per write unit may be adjusted according to practical needs, and the disclosure is not limited thereto.

According to the dynamically configured first data volume per write unit and second data volume per write unit, when the memory devices 121 and 122 perform a parallel data write, between time points T4(0) to T4(2), the data DATA(1) (also referred to as first data) and the DATA(2) (also referred to as second data)) may be written into the memory devices 121 and 122 in parallel. The data amount of the data DATA(1) conforms to the first data volume per write unit (for example, 128K), and the data amount of DATA(2) conforms to the second data volume per write unit (for example, 64K).

Compared with the embodiment in FIG. 4, before the memory device 122 finishes the writing of the data DATA(2) at the time point T4(2), although the memory device 121 might still finish the writing of the data DATA(1) at a time point T4(1), which is earlier than the time point T4(2), the length of a time range ΔT(idle)′ between the time points T4(1) and T4(2) may be significantly less than the time range ΔT(idle) between the time points T3(1) and T3(2) in FIG. 4.

In addition, after the time point T4(2), the memory devices 121 and 122 may continue to perform a next parallel data write. For example, between the time point T4(2) to a time point T4(4), the data DATA(3) and the data DATA(4) that conform to different data volumes per write unit may be written to the memory devices 121 and 122 in parallel, and so on.

In other words, in the embodiment of FIG. 5, by allowing the memory device 121 with a higher data writing performance to write more data in a single parallel data write (that is, the first data volume per write unit is greater than the second data volume per write unit), the time in which the memory device 121 is in the idle state may be effectively reduced (that is, ΔT(idle)′ is less than ΔT(idle)). In this way, the bandwidth resource utilization of the memory device 122 may be improved and/or the system performance of the entire data storage system may be improved accordingly.

In an embodiment, after the memory devices 121 and 122 perform at least one parallel data write according to the dynamically configured first data volume per write unit and second data volume per write unit, the amount of data stored in the memory device 121 is more than the amount of data stored in the memory device 122. Taking FIG. 5 as an example, in each parallel data write, the amount of data written to the memory device 121 may be two or other times larger than the amount of data written to the memory device 122. Therefore, in an embodiment, when the memory device 121 and/or 122 is in the idle state, the processor 111 may instruct the memory devices 121 and 122 to perform a data transfer operation to balance the data amount of the memory devices 121 and 122.

In an embodiment, after the memory devices 121 and 122 perform at least one parallel data write according to the dynamically configured first data volume per write unit and second data volume per write unit, the processor 111 may instruct the memory devices 121 and 122 to perform a data transfer operation to copy a part of the data (also referred to as third data) in the memory device 121 and store the third data to the memory device 122, and remove the third data in the memory device 121.

In an embodiment, in the data transfer operation, the processor 111 may transmit a read instruction to the memory device 121 via the channel 101 to instruct the memory device 121 to read the third data and send the third data to the host system 11. Next, the processor 111 may transmit a write instruction to the memory device 122 via the channel 102 to instruct the memory device 122 to store the third data previously read from the memory device 121 to the memory device 122. In addition, the processor 111 may transmit a delete instruction to the memory device 121 via the channel 101 to instruct the memory device 121 to delete the third data copied to the memory device 122.

In an embodiment, in response to the data transfer operation, the processor 111 may modify a flash translation layer (FTL) table or a similar management table. The modified FTL table or similar management table may reflect that the third data is moved from the memory device 121 to the memory device 122 (for example, moved from at least one store address located in the memory device 121 originally to at least one store address in the memory device 122). Thereafter, the processor 111 may normally access the moved third data from the memory device 122 according to the FTL table or similar management table as described above.

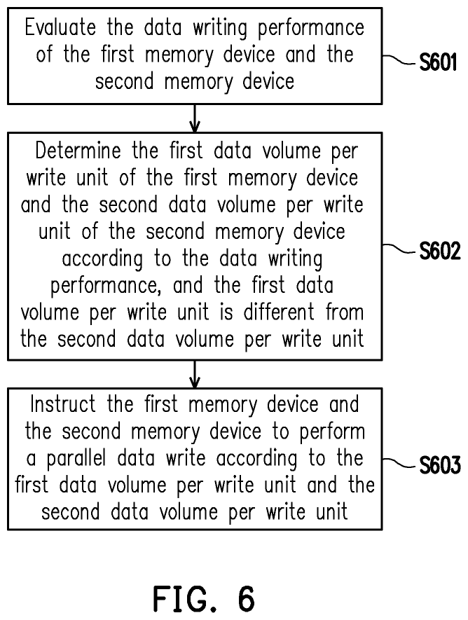

FIG. 6 is a flow chart of a method for writing data in parallel according to an embodiment of the disclosure. Referring to FIG. 6, in step S601, the data writing performance of the first memory device and the second memory device is evaluated. In step S602, the first data volume per write unit of the first memory device and the second data volume per write unit of the second memory device are determined according to the data writing performance. The first data volume per write unit is different from the second data volume per write unit. In step S603, the first memory device and the second memory device are instructed to perform a parallel data write according to the first data volume per write unit and the second data volume per write unit.

However, each step in FIG. 6 has been described in detail as above and will not be repeated herein. It is to be noted that each step in FIG. 6 may be implemented as a plurality of codes or circuits, and the disclosure is not limited thereto. In addition, the method in FIG. 6 may be used in connection with the above exemplary embodiment or used alone, and the disclosure is not limited thereto.

In summary, it is proposed in the embodiments of the disclosure that appropriate data volume per write unit may be dynamically configured for different memory devices in according to the difference in the data writing performance of the plurality of memory devices in the same data storage system (or RAID store system). Accordingly, the parallel data writing performance of the data storage system (or RAID store system) may be improved.

Although the disclosure has been disclosed in the above by way of embodiments, the embodiments are not intended to limit the disclosure. Those with ordinary knowledge in the technical field can make various changes and modifications without departing from the spirit and scope of the disclosure. Therefore, the scope of protection of the disclosure is defined by the scope of the appended claims.

What is claimed is:

1. A method for writing data in parallel, adapted for a data storage system, wherein the data storage system comprises a first memory device and a second memory device, and the method for writing data in parallel comprises:
evaluating a data writing performance of the first memory device and the second memory device;
determining a first data volume per write unit of the first memory device and a second data volume per write unit of the second memory device according to the data writing performance, wherein the first data volume per write unit is different from the second data volume per write unit; and
instructing the first memory device and the second memory device to perform a parallel data write according to the first data volume per write unit and the second data volume per write unit.

2. The method for writing data in parallel according to claim 1, wherein evaluating the data writing performance of the first memory device and the second memory device comprises:
measuring a first data write bandwidth of the first memory device and a second data write bandwidth of the second memory device; and
evaluating the data writing performance of the first memory device and the second memory device according to the first data write bandwidth and the second data write bandwidth.

3. The method for writing data in parallel according to claim 2, wherein measuring the first data write bandwidth of the first memory device and the second data write bandwidth of the second memory device comprises:
transmitting a first test write instruction to the first memory device;
measuring the first data write bandwidth of the first memory device according to a first response time of the first memory device with regard to the first test write instruction;
transmitting a second test write instruction to the second memory device; and
measuring the second data write bandwidth of the second memory device according to a second response time of the second memory device with regard to the second test write instruction.

4. The method for writing data in parallel according to claim 2, wherein determining the first data volume per write unit of the first memory device and the second data volume per write unit of the second memory device according to the data writing performance comprises:
determining the first data volume per write unit and the second data volume per write unit according to a ratio of the first data write bandwidth to the second data write bandwidth.

5. The method for writing data in parallel according to claim 1, wherein in the parallel data write, first data and second data are written into the first memory device and the second memory device in parallel, a data volume of the first data conforms to the first data volume per write unit, and a data volume of the second data conforms to the second data volume per write unit.

6. The method for writing data in parallel according to claim 1, further comprising:
after performing the parallel data write, instructing the first memory device and the second memory device to perform a data transfer operation to copy third data in the first memory device and store the third data to the second memory device, and removing the third data in the first memory device.

7. The method for writing data in parallel according to claim 1, further comprising:
in response to the data transfer operation, modifying a table to reflect that the third data is copied to the second memory device.

8. The method for writing data in parallel according to claim 1, wherein a first connection interface connected between a host system and the first memory device conforms to a PCIe Gen 4 specification, and a second connection interface connected between the host system and the second memory device conforms to a PCIe Gen 3 specification.

9. A data storage system, comprising:
a host system;
a first memory device, connected to the host system via a first connection interface; and
a second memory device, connected to the host system via a second connection interface,
wherein the host system is configured to evaluate a data writing performance of the first memory device and the second memory device,
the host system is further configured to determine a first data volume per write unit of the first memory device and a second data volume per write unit of the second memory device according to the data writing performance, wherein the first data volume per write unit is different from the second data volume per write unit, and
the host system is further configured to instruct the first memory device and the second memory device to perform a parallel data write according to the first data volume per write unit and the second data volume per write unit.

10. The data storage system according to claim 9, wherein the operation of evaluating the data writing performance of the first memory device and the second memory device comprises:
measuring a first data write bandwidth of the first memory device and a second data write bandwidth of the second memory device; and
evaluating the data writing performance of the first memory device and the second memory device according to the first data write bandwidth and the second data write bandwidth.

11. The data storage system according to claim 10, wherein measuring the first data write bandwidth of the first memory device and the second data write bandwidth of the second memory device comprises:
transmitting a first test write instruction to the first memory device;
measuring the first data write bandwidth of the first memory device according to a first response time of the first memory device with regard to the first test write instruction;
transmitting a second test write instruction to the second memory device; and
measuring the second data write bandwidth of the second memory device according to a second response time of the second memory device with regard to the second test write instruction.

12. The data storage system according to claim 10, wherein determining the first data volume per write unit of the first memory device and the second data volume per write unit of the second memory device according to the data writing performance comprises:
determining the first data volume per write unit and the second data volume per write unit according to a ratio of the first data write bandwidth to the second data write bandwidth.

13. The data storage system according to claim 9, wherein in the parallel data write, first data and second data are written into the first memory device and the second memory device in parallel, a data volume of the first data conforms to the first data volume per write unit, and a data volume of the second data conforms to the second data volume per write unit.

14. The data storage system according to claim 9, wherein after performing the parallel data write, the host system is further configured to instruct the first memory device and the second memory device to perform a data transfer operation to copy third data in the first memory device and store the third data to the second memory device and remove the third data in the first memory device.

15. The data storage system according to claim 9, wherein in response to the data transfer operation, the host system is further configured to modify a table to reflect that the third data is copied to the second memory device.

16. The data storage system according to claim 9, wherein the first connection interface conforms to a PCIe Gen 4 specification, and the second connection interface conforms to a PCIe Gen 3 specification.
